(19) United States
(12) Patent Application Publication
(10) Pub. No.: US 2010/0020470 A1
(43) Pub. Date: Jan. 28, 2010

(54) SYSTEMS, METHODS, AND APPARATUSES FOR BALANCING CAPACITOR LOAD

(75) Inventors: Howard Ross Edmunds, Roanoke, VA (US); Cyrus David Harbourt, Roanoke, VA (US); Amy Marlene Ridenour, Salem, VA (US); Jeffrey Alan Melius, Roanoke, VA (US)

Correspondence Address: SUTHERLAND ASBILL & BRENNAN LLP, 999 PEACHTREE STREET, N.E., ATLANTA, GA, 30309, US

(73) Assignee: General Electric Company, Schenectady, NY (US)

(21) Appl. No.: 12/179,679

(22) Filed: Jul. 25, 2008

(51) Int. Cl. H01G 4/38

(52) U.S. Cl. 361/329

(57) ABSTRACT

Systems, methods, and apparatuses for balancing capacitor load are provided. A system includes a plurality of capacitors, a plurality of respective positive connections and a plurality of respective negative connections that connect each of the plurality of capacitors to at least one power source, where each of the plurality of positive connections has an approximately equal length, and each of the plurality of negative connections has an approximately equal length.

### FIELD OF THE INVENTION

This invention relates generally to capacitor banks and more specifically, to systems, methods and apparatuses for balancing capacitor load.

### BACKGROUND OF THE INVENTION

Capacitor banks typically act as stores of energy and are often used in a variety of applications, such as, power converter drives for large Alternating Current (AC) motors, gas pumps, gas compressors, coolant pumps, etc. These applications may include medium voltage applications (greater than approximately 600 Volts), such as, a Variable Frequency Drive (VFD) utilized to control the rotational speed of an AC electric motor, or a variable frequency power converter utilized to convert one or more characteristics of an electric power system, for example, changing AC to Direct Current (DC).

In conventional capacitor banks, capacitors are typically arranged in a linear configuration. This conventional linear arrangement was adopted in part due to the large size of the capacitors involved in many conventional applications. Current flowing to and from the capacitors of the conventional capacitor banks follows the conduction path of least impedance. Therefore, current flow may be uneven, leading to stress in capacitors that have a smaller impedance to the current flow as compared to other capacitors. The stress can be both thermal (e.g., unbalanced heating of the capacitors) and electrical (e.g., overloaded current flow in the capacitors). These electrical and thermal stresses may lead to the early wear-out or failure or even a gradual decrease in the capacitance of the stressed capacitors, which may lead to the malfunctioning of devices like AC motors connected to these capacitors. Furthermore, even the maintenance of these large capacitors is very expensive.

Accordingly, there exists a need for systems, methods, and apparatus for balancing capacitor load. Further, there exists a need for improved capacitor banks that facilitate balancing of the stress, impedance and current load on all capacitors in the capacitor banks. Additionally, there exists a need for improved methods of arranging capacitors in the capacitor banks to balance the stress, impedance and current load on the capacitors.

### BRIEF DESCRIPTION OF THE INVENTION

According to one embodiment of the invention, there is disclosed a system for balancing capacitor loads. The system includes a plurality of capacitors, and a plurality of respective positive connections and a plurality of respective negative connections. The plurality of positive connections and negative connections connect each of the plurality of capacitors to at least one power source, where each of the plurality of positive connections has an equal length, and each of the plurality of negative connections has an equal length.

According to another embodiment of the invention, there is disclosed an apparatus that includes a plurality of capacitors geometrically arranged with respect to a common point, and a plurality of connections extending from the common point, where each of the plurality of connections facilitates the connection of at least one of the plurality of capacitors to at least one power source.

According to yet another embodiment of the invention, a method for balancing capacitor loads is disclosed. A plurality of capacitors is provided, where the plurality of capacitors are arranged with respect to a common point. The plurality of capacitors are connected to at least one power source with respective connections. The respective one or more connections utilized for a first of the plurality of capacitors have a length that is equal to that of the one or more connections utilized for the other capacitors of the plurality of capacitors.

Other embodiments, aspects, features, and advantages of the invention will become apparent to those skilled in the art from the following detailed description, the accompanying drawings, and the appended claims.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of one example of a system or apparatus in accordance with an illustrative embodiment of the invention.

FIG. 2 is a perspective view of the system, or apparatus of FIG. 1 with added power interconnections, according to an illustrative embodiment of the invention.

FIG. 3 is a perspective view of a second example of a system or apparatus in accordance with an illustrative embodiment of the invention.

FIG. 4 is a perspective view of a third example of a system or apparatus in accordance with an illustrative embodiment of the invention.

FIG. 5 is a circuit diagram of one example of connecting a power source to a system or apparatus, according to an illustrative embodiment of the invention.

FIG. 6 is a flowchart of one example of a method for arranging capacitors in a system or apparatus, according to an illustrative embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are systems, methods, and apparatuses for balancing load across a capacitor bank. The capacitor bank may be used in accordance with various embodiments of the invention to store charge on the capacitors that form the capacitor bank. The capacitor bank may include a plurality of capacitors arranged in such a way that the stress, impedance and current load on these capacitors are balanced. For the purposes of this disclosure, the term “load,” may be used interchangeably with the terms “stress,” “impedance,” and “current load”. A system may include a plurality of positive connections and a plurality of negative connections that connect correspondingly the plurality of capacitors to one or more one power sources. In certain embodiments of the invention, each of the plurality of positive connections may have an equal length and similarly each of the plurality of negative connections may have an equal length.

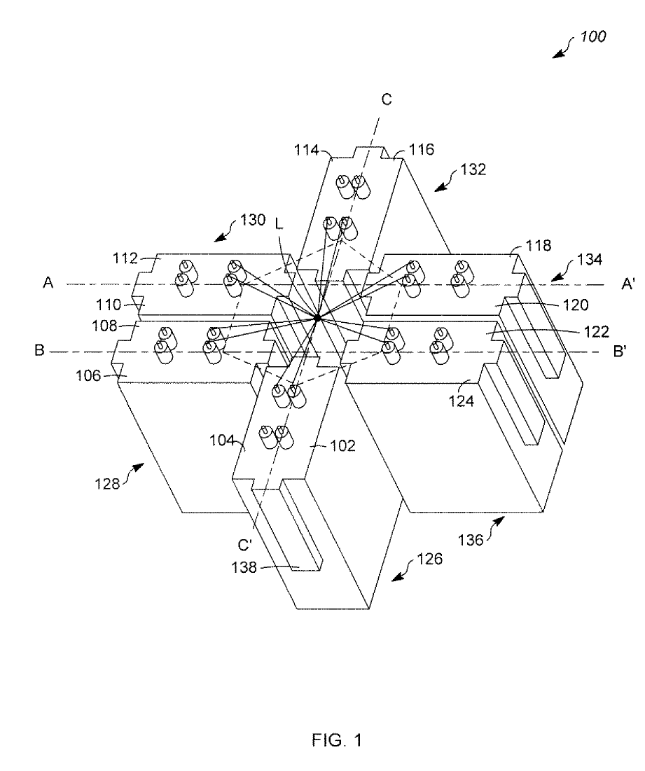

FIG. 1 is a perspective view of one example of a system or apparatus in accordance with an illustrative embodiment of the invention. FIG. 1 illustrates one example of an arrangement of capacitors in a capacitor bank 100 that may be used in medium voltage applications operating at a voltage above approximately 600 Volts (V). A medium voltage application may be, for example, a Variable Frequency Drive (VFD) that may control the rotational speed of an AC synchronous electric motor, or a variable frequency power converter to alter one or more characteristics of an electric power system, for example, changing Alternating Current (AC) to Direct Current (DC). Other applications for the capacitor bank 100, whether medium voltage or otherwise, will be readily apparent to those skilled in the art.

The capacitor bank 100 may function as a bank of energy where the capacitors are connected in parallel, or in a series parallel combination; however, other suitable configurations of the capacitors may be utilized as desired. In one embodiment, the capacitor bank 100 may include one or more capacitor blocks, each containing two capacitors. In other words, each capacitor block can be termed a “dual capacitor block”. Embodiments of the invention may include any number of capacitors and/or any number of capacitors in a capacitor block, depending on a desired energy storage need. In the capacitor bank 100 illustrated in FIG. 1, each capacitor block may have a wide variety of different capacitances as desired in various embodiments of the invention. In some embodiments, the capacitance of each capacitor block may depend on the energy needs of the application that uses the capacitor bank 100. As an example of capacitances, in some embodiments of the invention that include medium voltage DC link assemblies, each individual capacitor may have a capacitance in the range of approximately 500 uF to approximately 2000 uF at voltages from approximately 2000 V to approximately 6000 V. As another example, in some embodiments of the invention that include relatively low voltage DC link assemblies, each individual capacitor may have a capacitance in the range of approximately 8,000 uF to approximately 50,000 uF at voltages from approximately 2000 V to approximately 6000 V.

Embodiments of the invention may include any number of capacitors arranged in the capacitor bank 100. For example, as shown in FIG. 1, the capacitor bank 100 may include twelve capacitors, C1 102, C2 104, C3 106, C4 108, C5 110, C6 112, C7 114, C8 116, C9 118, C10 120, C11 122 and C12 124. As mentioned above, each capacitor block in the capacitor bank 100 may contain two capacitors. Moreover, the capacitance of the two capacitors in each capacitor block may be approximately equal in certain embodiments of the invention. Additionally, as shown in FIG. 1, all capacitors in the capacitor block may be arranged in a symmetrical geometry. The capacitor bank 100 may include capacitor blocks 126, 128, 130, 132, 134 and 136, where each capacitor block includes two capacitors. For example, as shown in FIG. 1, an axis A-A′ divides the capacitor blocks 130 and 134 into the capacitors C5 110, C6 112 and C9 118, C10 120, respectively. Similarly, an axis B-B′ divides the capacitor blocks 128 and 136 into the capacitors C3 106, C4 108 and C11 122, C12 124, respectively; and an axis C-C′ divides the capacitor blocks 126 and 132 into the capacitors C1 102, C2 104 and C7 114, C8 116, respectively. In one embodiment, the capacitors within the capacitor blocks 126, 128, 130, 132, 134 and 136 may be connected in parallel. In another embodiment, these capacitors may be connected in series parallel configuration. Also, the capacitor blocks shown in FIG. 1 may be geometrically symmetric in shape, size, and/or energy storage capacity.

Further, the arrangement of the capacitors in the capacitor bank 100 may be such that similar power terminals, for example the positive terminals of the capacitors C1 102, C8 116 and C2 104, C7 114, face each other. In one embodiment, the negative terminals of the capacitors C1 102, C8 116 and C2 104, C7 114 face each other. Accordingly, the similar power terminals of the capacitors C3 106, C12 124 and C4 108 and C11 122 face each other and the similar power terminals of the capacitors C5 110, C10 120 and C6 112, C9 118 face each other. Further, as shown in FIG. 1, the axes A-A′ and B-B′ may be approximately parallel to each other and the axis C-C′ may be approximately perpendicular to both the axes A-A′ and B-B′. A common point ‘L’ may be determined to connect the power terminals of the capacitors in the capacitor bank 100 to a power source (not shown). The common point ‘L’ may be defined as a point from which the distance to the positive terminal of each of the capacitors in the capacitor bank 100 is approximately equal. Similarly, the negative terminals of all the capacitors in the capacitor bank 100 may be approximately equidistant from the common point ‘L’. In various embodiments of the invention, the common point may lie on an axis passing through the common point ‘L’ and perpendicular to the plane formed by the axes A-A′ and B-B′.

For the purposes of this disclosure, the connections between the positive terminals of the capacitors in the capacitor bank 100 and the common point ‘L’ may be interchangeably referred to as ‘positive connections’ and similarly the connections between the negative terminals and the common point ‘L’ may be referred to as ‘negative connections’.

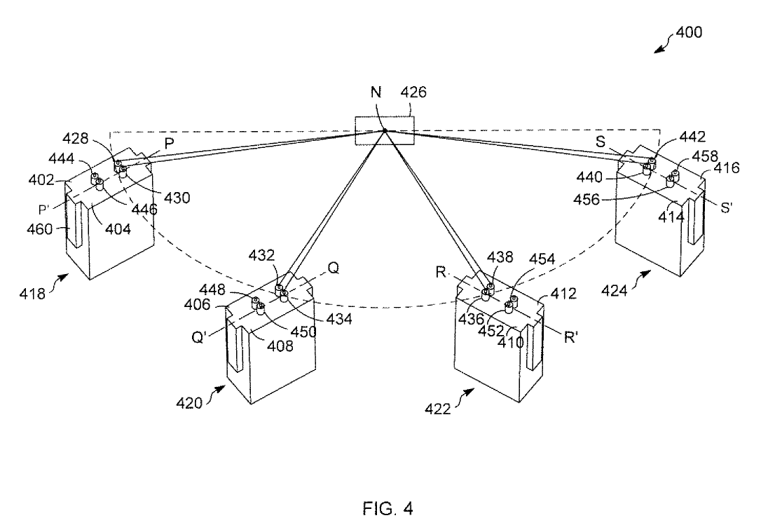

According to certain embodiments of the invention, the common point ‘L’ may be a central point for all capacitors in the capacitor bank 100. Thus, the arrangement of the capacitor blocks 126, 128, 130, 132, 134 and 136 is such that joining the positive terminals of all capacitors in the capacitors bank 100 forms a hexagonal geometry (shown as dotted lines in FIG. 1). The common point ‘L’ is at a central point from all sides of this hexagonal geometry. Therefore, all the positive connections are of approximately equal lengths. Similarly, the negative terminals of all capacitors in the capacitors bank 100 may be joined together to form a hexagonal geometry. In this case, all the negative connections are of approximately equal lengths. For the purposes of this disclosure, the arrangement shown in FIG. 1 may be referred to as “hexagonal design,” or “hexagonal arrangement,” or “hexagonal geometry”. However, in some cases the common point “L” may not be the central point, e.g., in a semi-circular arrangement of capacitors around a power source, which is explained in greater detail below with reference to FIG. 4.

In conventional arrangements of capacitors in a capacitor bank, e.g., where the capacitors were typically arranged linearly, the uneven resistance across the capacitors may cause uneven stresses on these capacitors. In the arrangement, energy flowing to and from these capacitors follows the conduction path of least resistance. In accordance with various embodiments of the invention, these uneven stresses on capacitors in the capacitor bank are removed or substantially removed as a function of the approximately equal length connections between all the capacitors (i.e., the C1 102, the C2 104, the C3 106, the C4 108, the C5 110, the C6 112, the C7 114, the C8 116, the C9 118, the C10 120, the C11 122 and the C12 124) and the common point ‘L’. Moreover, resistances to and from the capacitors in the capacitor bank 100 may be approximately matched as a result of the hexagonal geometry of these capacitors. As a result, the stresses, impedances and current loads applied to each of these capacitors are balanced, according to an aspect of the invention.

FIG. 1 further illustrates mounting feet 138 on the capacitor blocks 126, which may be optional in certain embodiments of the invention. The mounting feet 138 may be on a side of the capacitor block 126 that is perpendicular to a plane formed by the axes A-A′ and C-C′ either facing towards or facing away from the common point ‘L’. Similarly, mounting feet similar to mounting feet 138 may be on the sides of each capacitor blocks 128, 130, 132, 134 and 136. The mounting feet 138 may be used to mount the various capacitors included in the capacitor bank 100 and may provide mechanical support for the capacitors.

In various embodiments of the invention, a plurality of capacitor banks may be used in a variable frequency power converter. Due to the relatively large size of the capacitor bank 100 in accordance with certain embodiments of the invention, the capacitor bank 100 may be placed in outdoor environments. The capacitor bank 100 may be arranged on an elevated platform insulated from earth. The operating voltage of the capacitor bank 100 may be utilized in a determination of the level of insulation required.

According to an aspect of the invention, the capacitors used in the capacitor bank 100 in FIG. 1 may be DC link capacitors. A DC link capacitor may facilitate energy storage and act as a filter for the DC link voltage. In certain other embodiments of the invention, other types of capacitors may be utilized as desired. For example, embodiments of the invention may be applied to any capacitor design that contains capacitors connected in a parallel configuration independent of voltage and/or capacitance specifications.

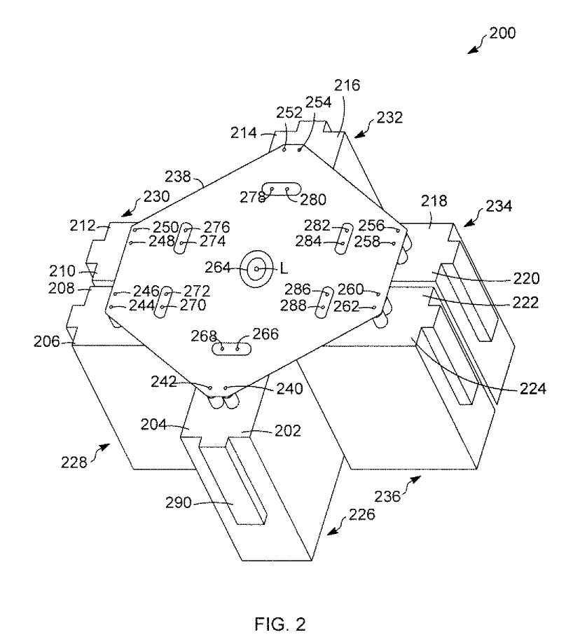

FIG. 2 is a perspective view of the system or apparatus of FIG. 1 with added power interconnections, according to an illustrative embodiment of the invention. In various embodiments of the invention, any number of power interconnections may be provided for the capacitor bank 100 illustrated in FIG. 1

FIG. 2 depicts a capacitor bank 200 that may include twelve capacitors C1 202, C2 204, C3 206, C4 208, C5 210, C6 212, C7 214, C8 216, C9 218, C10 220, C11 222 and C12 224 arranged in a geometry as explained above in conjunction with FIG. 1. Embodiments of the invention may include any number of capacitors, which may be arranged in capacitor blocks. For example, as shown in FIG. 2, C1 202 and C2 204; C3 206 and C4 208; C5 210 and C6 212; C7 214 and C8 216; C9 218 and C10 220; and C11 222 and C12 224 together form capacitor blocks 226, 228, 230, 232, 234 and 236, respectively.

With additional reference to FIG. 2, an interconnection plate 238 may be mounted on the capacitor bank 200, for example, on the top of the capacitor bank 200. The interconnection plate 238 may facilitate the connection of similar power terminals of each capacitor in the capacitor bank 200 to a power source. For example, the interconnection plate 238 may be used to connect positive terminals P1 240, P2 242, P3 244, P4 246, P5 248, P6 250, P7 252, P8 254, P9 256, P10 258, P11 260 and P12 262 of capacitors C1 202, C2 204, C3 206, C4 208, C5 210, C6 212, C7 214, C8 216, C9 218, C10 220, C11 222, and C12 224 respectively to a power source 264. The power source 264 may be situated at the common point ‘L’ or, alternatively, connections to the power source 264 may pass through the common point ‘L’. All these positive terminals face the common point ‘L’, as shown in FIG. 1. In one embodiment of the invention, the power source 264 may be connected to the capacitors in the capacitor bank 200 through one or more power semiconductors. In one embodiment of the invention, the power source 264 may be a DC power source, where the positive terminals of the capacitors C1 202, C2 204, C3 206, C4 208, C5 210, C6 212, C7 214, C8 216, C9 218, C10 220, C11 222 and C12 224 may be connected to a positive terminal (not shown) of the DC power source 264.

In various embodiments of the invention, negative terminals N1 266, N2 268, N3 270, N4 272, N5 274, N6 276, N7 278, N8 280, N9 282, N10 284, N11 286, and N12 288 of the capacitors C1 202, C2 204, C3 206, C4 208, C5 210, C6 212, C7 214, C8 216, C9 218, C10 220, C11 222, and C12 224 respectively may be connected to the power source 264. In another embodiment of the invention, these negative terminals may be connected to a different power source, (hereinafter referred to as other power source). In this case, the other power source may be electrically connected to the power source 264. In one embodiment of the invention, when the power source 264 is the DC power source, the negative terminals may be connected to a negative terminal (not shown) of the DC power source 264. In certain embodiments of the invention, more than two power sources may also be used. Examples of power sources that may be utilized in various embodiments of the invention include, but are not limited to, a 6 pulse diode bridge transforming 3 phase AC to DC, a 12 pulse diode bridge (e.g., two 6 pulses in series) transforming 2 three phase AC voltages to DC, an 18 pulse diode bridge (e.g., three 6 pulses in series) transforming 3 three phase AC voltages to DC, multiple singe phase AC sources rectified and added in series to form DC, one or more 2 level insulated-gate bipolar transistor (IGBT)/integrated-gate commutated thyristor (IGCT) bridges in series transforming multiple 3 phase inputs to DC, and/or one or more 3 level IGBT/IGCT bridges in series transforming multiple 3 phase inputs to DC.

In certain embodiments of the invention, the interconnection plate 238 may connect only the positive terminals to the power source 264 and may be insulated at the negative terminals. In such cases, an additional interconnection plate (not shown) may be used to connect the negative terminals of the capacitor with the power source 264. In one embodiment of the invention, the additional interconnection plate may be insulated at the positive terminals of the capacitor to avoid a short circuit. The additional interconnection plate may be arranged in parallel above or below the interconnection plate 238. In one embodiment of the invention, the interconnection plate 238 may be a hexagonal plate made up of an electrically conductive material. In an embodiment of the invention, an electrically conductive material, such as, Copper (Cu) wire or Aluminum (Al) wire, etc., may be used to connect the negative terminals of the capacitors to the power source 264. In the type of arrangement shown in FIG. 2, if the power source 264 is placed at the common point ‘L’, then the interconnection extends from the common point ‘L’ to each capacitor terminal on the capacitor bank 200. In various embodiments of the invention, the common point ‘L’ may not be the central point (as will be explained later in conjunction with FIG. 4) for all capacitors in the capacitor bank 200. However, the lengths of the connections from the power source 264 to each capacitor terminal are approximately equal. In various embodiments of the invention, the power source 264 may be placed anywhere on an axis passing through common point ‘L’. In other embodiments, the connections leading to the power source 264 may pass through common point ‘L’. Therefore, the lengths of the connections between the capacitor terminals and the power source 264 may remain approximately equal.

As a result of the arrangement shown in FIG. 2, approximately equal length positive connections and approximately equal length negative connections are created between the capacitors (i.e., C1 202, C2 204, C3 206, C4 208, C5 210, C6 212, C7 214, C8 216, C9 218, C10 220, C11 222 and C12 224) and the power source 264. Moreover, resistances to and from the capacitors in the capacitor bank 200 are approximately matched due to the hexagonal geometry of these capacitors. As a result, the stresses, impedances and current loads applied to each of these capacitors are balanced, according to an aspect of the invention.

FIG. 2 further illustrates mounting feet 290 on the capacitor blocks 226, 228, 230, 232, 234 and 236. The position of the mounting feet 290 may be similar to that described above for the mounting feet 138 in conjunction with FIG. 1.

Further, according to certain embodiments of the invention, the power source 264 may be a medium voltage power source having a voltage greater than approximately 600 V. Additionally, in some embodiments of the invention, the power source 264 may be an AC power source. Alternatively, the power source 264 may be a DC power source, in which case the positive connections connect the positive terminals of the capacitors in the capacitor bank 200 with the positive terminal of the DC power source 264 and the negative connections connect the negative terminals of these capacitors with the DC power source 264.

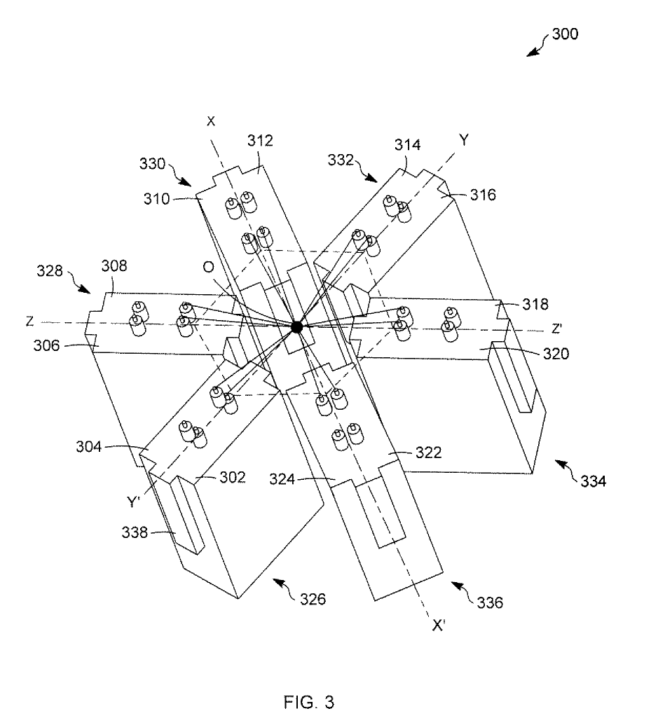

FIG. 3 is a perspective view of a second example of a system or apparatus in accordance with an illustrative embodiment of the invention. FIG. 3 illustrates another example of an arrangement of capacitors in a capacitor bank 300 that may be utilized in a wide variety of different applications, such as, in medium voltage applications.

Embodiments of the invention may include any number of capacitors arranged in the capacitor bank 300. For example, as shown in FIG. 3, the capacitor bank 300 may include twelve capacitors C1 302, C2 304, C3 306, C4 308, C5 310, C6 312, C7 314, C8 316, C9 318, C10 320, C11 322 and C12 324. In some embodiments, the capacitors may be arranged into capacitor blocks. For example, the capacitors may be arranged into capacitor blocks that each contain two capacitors, any number of capacitors may be included in a capacitor block. When arranged into capacitor blocks with two capacitors, the capacitance of the two capacitors in each capacitor block may be approximately equal. As shown in FIG. 3, all capacitors in each capacitor block may be arranged in a symmetrical geometry. Therefore, the positive terminals of each capacitor in a capacitor block may be paired together, as are the negative terminals of each capacitor. The capacitor bank 300 may include capacitor blocks 326, 328, 330, 332, 334 and 336, where each capacitor block includes two capacitors. For example, as shown in FIG. 1, an axis X-X′ may divide the capacitor blocks 330 and 336 into the capacitors C5 310, C6 312 and C11 322, C12 324, respectively. Similarly, an axis Y-Y′ may divide the capacitor blocks 326 and 332 into the capacitors C 1302, C2 304 and C7 314, C8 316, respectively; and an axis Z-Z′ may divide the capacitor blocks 328 and 334 into the capacitors C3 306, C4 308 and C9 318, C10 320, respectively. In one embodiment, the capacitors within the capacitor blocks 326, 328, 330, 332, 334 and 336 may be connected in parallel. In another embodiment, these capacitors may be connected in a series parallel configuration. Also, the capacitor blocks shown in FIG. 3 may be geometrically symmetric in shape and size in certain embodiments of the invention.

Further, the arrangement of the capacitors in the capacitor bank 300 may be such that similar power terminals, for example, the positive terminals of the capacitors C1 302, C8 316 and C2 304, C7 314, face each other. In one embodiment, the negative terminals of the capacitors C1 302, C8 316 and C2 304, C7 314 may face each other. Accordingly, the similar power terminals of the capacitors C3 306, C10 320 and C4 308, C11 322 may face each other and the similar power terminals of the capacitors C5 310, C12 324 and C6 312, C11 322 face each other.

Further, a common point ‘O’ may be determined to connect the power terminals of the capacitors of the capacitor bank 300 to a power source (not shown). The common point ‘O’ may be defined as a point from which the distance to the positive terminal of each capacitor in the capacitor bank 300 is approximately equal. Similarly, the negative terminals of all the capacitors in the capacitor bank 300 may be approximately equidistant from the common point ‘O’. The common point ‘O’ may also be defined with respect to an intersection point of the axes X-X′, Y-Y′ and Z-Z′ such that the angles formed (e.g., angle ZOY′) due to this intersection are approximately equal, such as, approximately 60 degrees each. Therefore, as shown in FIG. 3 the capacitor blocks are arranged at an angle of 60 degrees or multiples of 60 degrees with respect to each other. In various embodiments of the invention, the angles formed between the axes may depend on the number of capacitor blocks used in the capacitor bank 300. For example, the angles between the capacitor blocks may be approximately 40 degrees in the event that nine capacitor blocks are used in the capacitor bank 300 to maintain symmetry in arrangement. Alternatively, certain capacitor blocks may be situated in close proximity with one another as desired in various embodiments, as shown in FIG. 1. In various embodiments of the invention, the common point may lie on an axis passing through the common point ‘O’ and perpendicular to the plane formed by the axes X-X′ and Y-Y′.

In certain embodiments of the invention, the common point ‘O’ may a central point for all capacitors in the capacitor bank 300. Thus, the arrangement of these capacitor blocks 326, 328, 330, 332, 334 and 336 may be such that joining the positive terminals of all the capacitors in the capacitors bank 300 forms a hexagonal geometry (shown as dotted lines in FIG. 3). The common point ‘O’ may be at a central point from all sides of this hexagonal geometry. Therefore, all the positive connections may be of approximately equal lengths. Similarly, negative terminals of all capacitors in the capacitors bank 300 may be joined together to form a hexagonal geometry. In this case, all the negative connections may be of approximately equal lengths. The X-X′, Y-Y′ and Z-Z′ axes shown in FIG. 3 suggest a star arrangement of capacitors. Thus, for the purposes of this disclosure, the arrangement shown in FIG. 3 may be referred to as “star design,” or “star arrangement,” or “star geometry”.

As a result of the arrangement shown in FIG. 3, the lengths of the connections between all the capacitors (i.e., C1 302, C2 304, C3 306, C4 308, C5 310, C6 312, C7 314, C8 316, C9 318, C10 320, C11 322 and C12 324) and the common point ‘O’ are approximately equal. Moreover, resistances to and from the capacitors in the capacitor bank 300 may be approximately matched due to the star geometry of these capacitors. As a result, the stresses, impedances and current loads applied to each of these capacitors are balanced, according to an aspect of the invention.

FIG. 3 further illustrates mounting feet 338 on the capacitor blocks 326, 328, 330, 332, 334 and 336. The position of the mounting feet 338 may be similar to that described above for the mounting feet 138 in conjunction with FIG. 1.

In one embodiment of the invention, two interconnection plates (similar to the interconnection plate 238 explained earlier in conjunction with FIG. 2) may be used to connect the power terminals of all the capacitors (i.e., the C1 302, the C2 304, the C3 306, the C4 308, the C5 310, the C6 312, the C7 314, the C8 316, the C9 318, the C10 320, the C11 322 and the C12 324) with a power source (similar to the power source 264 explained earlier in conjunction with FIG. 2), which may be placed at the common point ‘O’. Alternatively, in another embodiment of the invention, one or more electrically conductive wires may be used to connect the capacitor terminals in the capacitor bank 300 with the power source.

FIG. 4 is a perspective view of a third example of a system or apparatus in accordance with an illustrative embodiment of the invention. FIG. 4 illustrates yet another example of an arrangement of capacitors in a capacitor bank 400 that may be used in various applications, such as, medium voltage applications.

Embodiments of the invention may include any number of capacitors arranged in the capacitor bank 400. For example, as shown in FIG. 4, the capacitor bank 400 may include eight capacitors C1 402, C2 404, C3 406, C4 408, C5 410, C6 412, C7 414 and C8 416. The capacitor bank may be arranged into one or more capacitor blocks in certain embodiments of the invention. Each capacitor block in the capacitor bank 400 may contain any number of capacitors, such as, two capacitors. Moreover, the capacitances of the two capacitors in each dual capacitor block may be equal. As shown in FIG. 4, all the capacitors in the capacitor block may be arranged in a symmetrical geometry. Therefore, the positive terminals of each capacitor in a capacitor block are paired together, as are the negative terminals of each capacitor. For example, as shown in FIG. 4, axes P-P′, Q-Q′, R-R′ and S-S′ divides capacitor blocks 418, 420, 422 and 424 into the capacitors C1 402 and C2 404, C3 406 and C4 408, C5 410 and C6 412, and C7 414 and C8 416, respectively. In one embodiment, the capacitors within the capacitor blocks 418, 420, 422 and 424 may be connected in parallel. In another embodiment, these capacitors may be connected in a series parallel configuration. Also, the capacitor blocks show in FIG. 4 are geometrically symmetric in shape and size.

Further, the arrangement of the capacitors in the capacitor bank 400 is such that similar power terminals, for example the positive terminals of these capacitors, may face a power source 426. A common point ‘N’ may be determined to connect the power terminals of the capacitors in the capacitor bank 400 to the power source 426. The common point ‘N’ may be defined as a point from which the distance of positive terminals P1 428, P2 430, P3 432, P4 434, P5 436, P6 438, P7 440, and P8 442 of all the capacitors in the capacitor bank 400 is equal. Similarly, the negative terminals N1 444, N2 446, N3 448, N4 450, N5 452, N6 454, N7 456, and N8 458 of all the capacitors in the capacitor bank 400 may be equidistant from the common point ‘N’. In various embodiments of the invention, the common point may lie on an axis passing through the common point ‘N’ and perpendicular to the plane formed by the axes Q-Q′ and R-R′.

According to an aspect of the invention, the arrangement of the capacitor blocks 418, 420, 422 and 424 may be such that if the similar power terminals of these capacitor blocks and the common point ‘N’ are connected, a semi-circular geometry is formed. In this semi-circular arrangement, the common point ‘N’ may be at the center of this semi-circle and the capacitor blocks 418, 420, 422, and 424 are placed on the circumference of the semi-circle. In this semi-circular geometry, all the positive connections extending from the common point ‘N’ to the positive terminal of each capacitor in the capacitor bank 400 are of approximately equal lengths. Similarly, all the negative connections are of approximately equal lengths. For the purposes of this disclosure, the arrangement shown in FIG. 4 may be referred to as “semi-circular design,” or “semi-circular arrangement,” or “semi-circular geometry”.

As a result of the arrangement shown in FIG. 4, approximately equal length positive connections and approximately equal length negative connections are created between the capacitors (i.e., C1 402, C2 404, C3 406, C4 408, C5 410, C6 412, C7 414 and C5 416) and the common point ‘N’. Moreover, resistances to and from the capacitors in the capacitor bank 400 may be approximately matched due to the semi-circular geometry of these capacitors. As a result, the stresses, impedances and current loads applied to each of these capacitors are approximately balanced, according to an aspect of the invention.

FIG. 4 further illustrates mounting feet 460 on the capacitor blocks 418, 420, 422 and 424. The position of the mounting feet 460 may be similar to that described above for the mounting feet 138 in conjunction with FIG. 1.

In the type of arrangement shown in FIG. 4, the power source 426 may be placed at the common point ‘N’ of the capacitor bank 400. As shown in FIG. 4, the capacitors in the capacitor bank 400 may be geometrically arranged with respect to the common point ‘N’.

In various embodiments of the invention, the power source 426 may be connected to the positive terminals P1 428, P2 430, P3 432, P4 434, P5 436, P6 438, P7 440, and P8 442 of the capacitors C1 402, C2 404, C3 406, C4 408, C5 410, C6 412, C7 414 and C5 416, respectively with any suitable positive connections, such as, electrically conductive wires (e.g., Cu or Al). Alternatively, in one embodiment of the invention, instead of electrically conductive wires, an interconnection plate (not shown) may be mounted on top of the capacitor bank 400 to connect all the positive terminals of the capacitors C1 402, C2 404, C3 406, C4 408, C5 410, C6 412, C7 414 and C8 416 to the power source 426. In various embodiments of the invention, the negative terminals N1 444, N2 446, N3 448, N4 450, N5 452, N6 454, N7 456, and N8 458 of the capacitors, C1 402, C2 404, C3 406, C4 408, C5 410, C6 412, C7 414 and C8 416, respectively may be connected (using negative connections) to the same power source 426. In another embodiment of the invention, these negative terminals may be connected to a different power source (not shown). In this case, the different power source may be electrically connected to the power source 426. In certain embodiments of the invention, more than two power sources may also be used.

In one embodiment of the invention, the above-mentioned interconnection plate may connect only the positive terminals to the power source 426 and may be insulated at the negative terminals. In such cases, an additional interconnection plate (not shown) may be used to connect the negative terminals of the capacitor with the power source 462. In one embodiment of the invention, the additional interconnection plate may be insulated at the positive terminals of the capacitor to avoid a short circuit. The additional interconnection plate may be arranged in parallel above or below the other interconnection plate. The interconnection plate may be a semi-circular plate made up of an electrically conductive material, in accordance with one embodiment of the invention. In another embodiment of the invention, the shape of the interconnection plate is that of a sector of a circle. In one embodiment of the invention, an electrically conductive wire may be used to connect the negative capacitor terminals to the power source 426.

FIG. 4 further illustrates mounting feet 460 on the capacitor blocks 418, 420, 422 and 424. The position of the mounting feet 460 may be similar to that described above for the mounting feet 138 in conjunction with FIG. 1.

In one embodiment of the invention, low inductance power structures may be used to achieve balanced load on capacitors in the capacitor bank. In another embodiment of the invention, the capacitors in the capacitor bank may be arranged in such a way so that the capacitor terminals face each other, in order to balance load on the capacitors.

It will be appreciated that a wide variety of different capacitor arrangements may be utilized in accordance with various embodiments of the inventions. Each of these arrangements may include capacitors that have respective positive connections to a power source of approximately equal length. Additionally, each of these arrangements may include capacitors that have respective negative connections to the power source of approximately equal length. These arrangements may or may not include geometrical arrangements of the capacitors.

Additionally, in certain embodiments of the invention, capacitors may be arranged such that the total length of the positive and negative connections for a first capacitor is approximately equal to the total length of the positive and negative connections for the other capacitors in the capacitor bank.

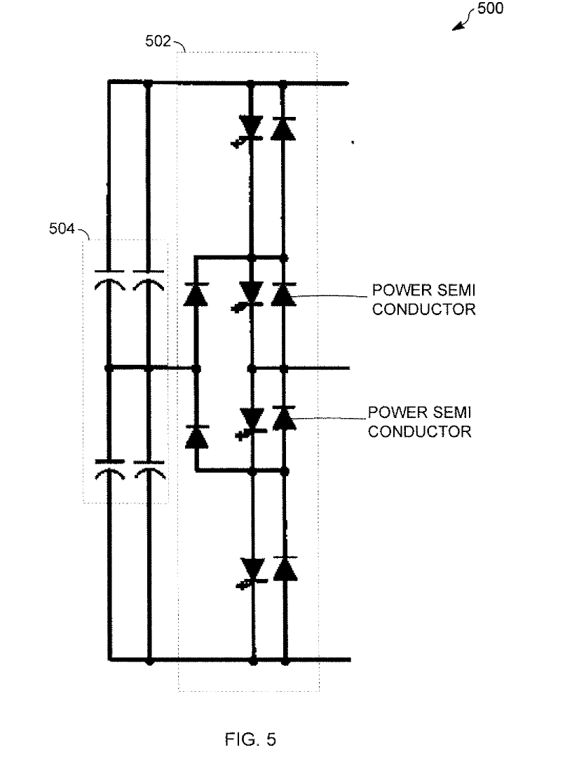

FIG. 5 is a circuit diagram 500 of one example of connecting a power source (not shown) to a system or apparatus, according to an illustrative embodiment of the invention. In certain embodiments, the power source may be an AC power source, such as power source 426, used to supply and receive AC power to and from a power converter 502. The power converter 502 may include a plurality of power semiconductors which operate to perform power conversion. Moreover, the power converter 502 may be used to provide the necessary electrical power to an AC motor (not shown). The AC motor may be a three-phase synchronous AC motor, in accordance with one embodiment of the invention. In this case, the power converter 502 may generate three-phase electrical power for the three phase asynchronous AC motor. In one embodiment of the invention, the power converter 502 may be a multi-phase converter and thus may generate multi-phase power. The power converter 502 may have a number of phases in a multiple of three. Additionally, in certain embodiments of the invention, the power converter 502 may be operated from plurality of power sources (not shown).

In certain embodiments of the invention, the power converter 502 may be an AC-to-AC converter. In this case, the AC power source may supply three-phase AC power at a first frequency, and the AC-to-AC converter 502 may convert the first frequency of the received AC power to a second frequency that is suitable for the AC motor. For example, the AC-to-AC converter 502 may convert a 400 Hertz (Hz) AC power to a variable frequency power and thereafter may supply the variable frequency power to the AC motor.

Referring to FIG. 5, the power converter 502 may be connected to a capacitor bank 504 at the power source side. The capacitor bank 504 may include any number of capacitors, such as four capacitors, and may store electrical energy to be supplied to the AC motor. In an embodiment of the invention, the capacitor bank 504 may be a three phase capacitor bank. In another embodiment of the invention, the capacitors in the capacitor bank 504 may be DC link capacitors that supply DC power. In this case, the power converter 502 used may be a DC-to-AC converter. The DC-to-AC converter 502 may convert a DC voltage fed from the DC link capacitor bank 504 into an AC phase voltage. Therefore, the DC-to-AC converter 502 may be utilized to drive the AC motor.

It will be apparent to a person skilled in the art that the value of ranges given in the above embodiments are provided by way of example only and are not intended to limit or deviate the scope of the invention.

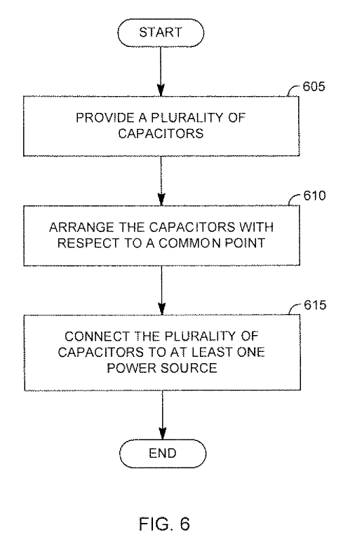

FIG. 6 is a flowchart of one example of a method 600 for arranging capacitors in a system or apparatus, according to an illustrative embodiment of the invention.

The method 600 may begin at block 605. At block 605, a plurality of capacitors, such as DC link capacitors that form a capacitor bank for use in a medium voltage application, may be provided. Block 605 may be followed by block 610, in which the capacitors may be arranged with respect to a common point of the capacitors. In certain embodiments of the invention, the common point may be a central point for all the capacitors in the capacitor bank. A power source may be placed at this common point and/or at the central point. In other embodiments, the common point may not be the central point. In certain embodiments of the invention, the capacitors may be arranged symmetrically with respect to the common point. Additionally, in certain embodiments of the invention, the capacitors may be geometrically arranged with respect to the common point.

Block 610 may be followed by block 615, in which the capacitors may be connected to at least one power source. In one embodiment of the invention, positive connections (e.g., wires or power interconnections) may be extended from the power source to the positive terminal of each capacitor such that the lengths of all positive connections are approximately equal. Similarly, negative connections may be extended from the same or a different power source to the negative terminals of each of the capacitors such that the lengths of the negative connections are approximately equal. The approximately equal length positive connections and approximately equal length negative connections may facilitate the balancing of stresses, impedances and current loads applied to each of the capacitors in the capacitor bank. In certain embodiments of the invention, the power source may be a medium voltage power source having a voltage above 600 volts. In certain embodiments, the power source may be an AC power source. More than one power source may be utilized as desired in various embodiments of the invention, and the plurality of power sources may be connected to the capacitors using suitable positive and negative connections.

The method 600 may end following block 615.

The operations described in the method 600 of FIG. 6 do not necessarily have to be performed in the order set forth in FIG. 6, but instead may be performed in any suitable order. Additionally, in certain embodiments of the invention, more or less than all of the elements or operations set forth in FIG. 6 may be performed.

Balancing stresses on the capacitors in a capacitor bank in accordance with various embodiments of the invention may increase the reliability of these capacitors, thereby reducing maintenance cost, and improving the overall performance of the capacitors and/or systems in which the capacitors are utilized. Additionally, the power interconnection designs explained above will not only encourage balanced current flow, but will also lower the inductance of the power connections between the capacitors and the power source.

Certain embodiments of the invention are applicable for any device, which requires storing charge or electrical energy. The capacitor design explained above may be utilized in a wide variety of different applications such as, but not limited to, large AC motors, gas pumping, gas compressors, coolant pumps, etc. It will be apparent that any example provided in the foregoing specification is merely provided for explanation purposes and does not limit the scope of the invention by any means.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

This written description uses examples to disclose embodiments of the invention, including the best mode, and also to enable any person skilled in the art to practice the invention, including making and using any devices or systems and performing any incorporated methods. The patentable scope of embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The claimed invention is:

1. A system for balancing capacitor loads, the system comprising:
a plurality of capacitors; and
a plurality of respective positive connections and a plurality of respective negative connections that connect each of the plurality of capacitors to at least one power source,
wherein each of the plurality of positive connections has an approximately equal length, and
wherein each of the plurality of negative connections has an approximately equal length.

2. The system of claim 1, wherein the plurality of capacitors comprise direct current link capacitors.

3. The system of claim 1, wherein each of the plurality of positive connections and each of the plurality of negative connections extends from a common point to an associated capacitor of the plurality of capacitors.

4. The system of claim 3, wherein the common point comprises a central point, and wherein the plurality of capacitors are situated around the central point.

5. The system of claim 1, wherein the plurality of capacitors are geometrically arranged with respect to a common point.

6. The system of claim 5, wherein the plurality of capacitors are geometrically arranged around the common point.

7. The system of claim 1, wherein the at least one power source comprises at least one medium voltage power source having a voltage above approximately 600 volts.

8. The system of claim 1, wherein the at least one power source comprises an alternating current power source.

9. The system of claim 1, wherein the plurality of positive connections with an approximately equal length and the plurality of negative connections with an approximately equal length facilitate balancing respective stresses applied to each of the plurality of capacitors.

10. An apparatus, comprising:
a plurality of capacitors geometrically arranged with respect to a common point; and
a plurality of connections extending from the common point,
wherein each of the plurality of connections facilitates the connection of at least one of the plurality of capacitors to at least one power source.

11. The apparatus of claim 10, wherein the plurality of connections comprises a plurality of positive connection and a plurality of negative connections, wherein a length of each of the plurality of positive connections is approximately equal, and wherein a length of each of the plurality of negative connections is approximately equal.

12. The apparatus of claim 10, wherein the plurality of capacitors comprise direct current link capacitors.

13. The apparatus of claim 10, wherein the common point comprises a central point, and wherein the plurality of capacitors are geometrically arranged around the central point.

14. The apparatus of claim 10, wherein the at least one power source comprises at least one medium voltage power source having a voltage above 600 volts.

15. A method for balancing capacitor loads, the method comprising:
providing a plurality of capacitors;
arranging the plurality of capacitors with respect to a common point; and
connecting the plurality of capacitors to at least one power source with respective connections,
wherein the respective one or more connections utilized for a first of the plurality of capacitors have a length that is approximately equal to that of the one or more connections utilized for the other capacitors of the plurality of capacitors.

16. The method of claim 15, wherein arranging the plurality of capacitors with respect to a common point comprises geometrically arranging the plurality of capacitors around the common point.

17. The method of claim 15, wherein providing a plurality of capacitors comprises providing a plurality of direct current link capacitors.

18. The method of claim 15, wherein connecting the plurality of capacitors to at least one power source comprises connecting the plurality of capacitors to at least one medium voltage power source having a voltage above 600 volts.

19. The method of claim 15, wherein connecting the plurality of capacitors to at least one power source comprises connecting the plurality of capacitors to at least one alternating current power source.

20. The method of claim 15, wherein connecting the plurality of capacitors to at least one power source with respective connections comprises connecting the plurality of capacitors to facilitate balancing respective stresses applied to each of the plurality of capacitors.
